(19) United States
(12) Patent Application Publication
(10) Pub. No.: US 2026/0195722 A1
(43) Pub. Date: Jul. 9, 2026

(54) System and Methodology for a Social App Bar Toggle

(71) Applicant: Grant Jameson, Johnston, IA (US)

(72) Inventor: Grant Jameson, Johnston, IA (US)

(21) Appl. No.: 19/009,029

(22) Filed: Jan. 3, 2025

(51) Int. Cl. G06Q 10/42; G06F 3/04842; G06F 40/274

(52) U.S. Cl. CPC G06Q 10/42; G06F 3/04842; G06F 40/274

(57) ABSTRACT

The invention pertains to a Bar Toggle Feature integrated within a dating application, designed to facilitate real-time visibility and context-sensitive matchmaking. Users activate the toggle to signal availability and input planned venues, enabling the system to dynamically filter profiles and prioritize matches based on shared intent and proximity. The invention combines advanced geolocation algorithms, error-handling protocols, and a responsive graphical user interface to redefine the online dating experience. By bridging real-time user intent with optimized matchmaking, the system offers a transformative approach to fostering meaningful connections.

### BACKGROUND OF THE INVENTION

This invention pertains to the intersection of computer science, social networking, and behavioral informatics, focusing on the optimization of user interactions within digital dating ecosystems. Specifically, the invention addresses a critical gap in the design and functionality of contemporary dating applications, wherein the temporal and locational context of users' intentions is not adequately utilized to enhance matchmaking efficacy.

Traditional dating applications operate on static profiles and generalized algorithms that do not incorporate real-time variables such as users' availability or immediate social plans. This limitation results in inefficiencies, such as users engaging with profiles that lack relevance to their current social context or intent. The absence of dynamic features that reflect users' immediate plans or preferences exacerbates user dissatisfaction and diminishes engagement.

The rapid evolution of digital platforms necessitates innovative methodologies that leverage real-time data to create more relevant and engaging user experiences. However, existing applications lack a cohesive framework to integrate immediate, user-driven intent signaling-such as a plan to visit a specific bar or venue-into their matchmaking algorithms. This deficiency underscores the necessity of a novel system that aligns real-world activities with online interactions, fostering more meaningful connections.

Furthermore, current systems fail to provide granular control over visibility and filtering mechanisms, often leading to non-targeted interactions and suboptimal user matches. Addressing this gap requires a sophisticated architecture that dynamically adjusts user visibility and matchmaking parameters in response to context-sensitive inputs, such as a user's declared intent to visit a bar, venue, or other social destination.

### BRIEF SUMMARY OF THE INVENTION

The present invention introduces a comprehensive system and method for dynamically integrating real-time user intent into a dating application. Referred to as the Bar Toggle Feature, this innovation allows users to signal their intent to participate in social activities, specifically by enabling a toggle indicating their availability for the evening. This toggle tuns off after a given amount of time and then can be reactivated by the user. Users can further specify their intended destination, such as the name of a bar or venue, through an integrated input mechanism.

The invention's core functionality dynamically filters user profiles based on toggle activation and contextual input. Only users who have activated the bar toggle and declared their venue plans are visible and eligible for matching during the specified timeframe. This filtering mechanism, coupled with advanced geolocation algorithms and proximity matching modules, ensures that matches are contextually relevant, temporally aligned, and spatially optimized.

The system further enhances user experience through real-time synchronization of profile visibility, venue-based filtering, and interactive notifications. By aligning user intent with immediate matchmaking capabilities, the invention significantly improves the relevance and quality of connections within the dating application.

This invention redefines the framework of online dating by seamlessly integrating real-time user intent into the operational paradigm of dating applications, offering a transformative solution that bridges online engagement with real-world social interactions.

### DETAILED DESCRIPTION OF THE INVENTION

### Bar Toggle Feature and Activation Mechanism

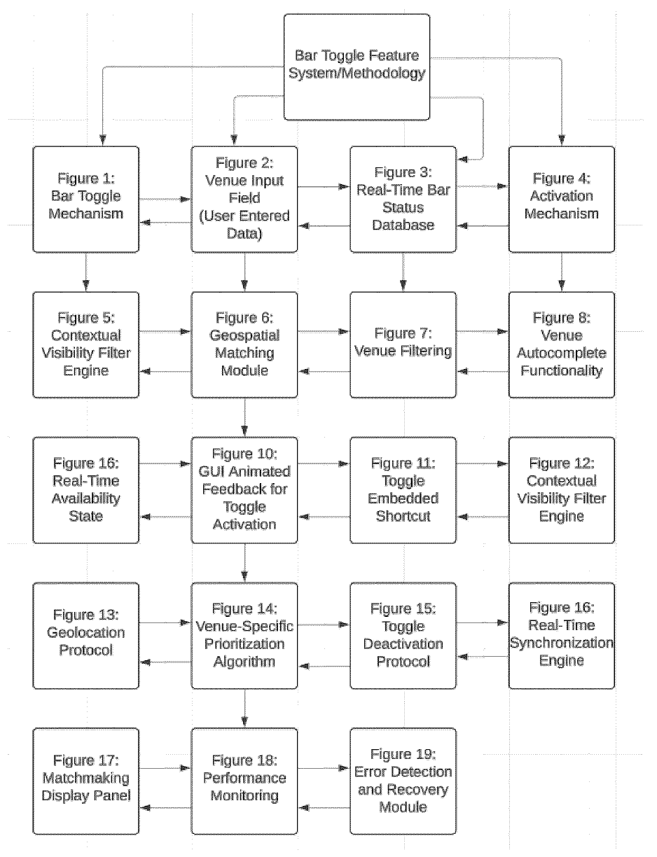

At the heart of this invention lies the Bar Toggle Feature, a user-activated mechanism that dynamically modifies the operational parameters of the dating application. The toggle interface is embedded prominently within the application's user interface (UI) (FIG. 1), ensuring accessibility and ease of use. When activated, the toggle transitions the user's profile into a real-time availability state, signaling their intent to participate in social activities for the evening.

Upon activation, the system prompts the user to input a specific bar or venue name via a dedicated text input field (FIG. 2). The entered data is transmitted to the Real-Time Bar Status Database (RTBSD) (FIG. 3), a secure, cloud-based repository designed to handle high-frequency updates and enable rapid filtering of user profiles.

The toggle is equipped with dual activation mechanisms, allowing users to initiate the feature either manually or via a predefined shortcut embedded in the application's home screen (FIG. 4). A visual confirmation indicator confirms successful activation and provides real-time feedback on the toggle's status.

### Dynamic Visibility Filtering and Contextual Matching

Once the bar toggle is activated, the system dynamically filters user profiles to display only those who have similarly activated their toggle and entered corresponding venue data. This process is executed by the Contextual Visibility Filter Engine (CVFE) (FIG. 5), a modular component designed to optimize the visibility parameters of user profiles based on location, time, and declared intent.

The CVFE integrates with the application's Geospatial Matching Module (GMM) (FIG. 6) to refine the filtering process. The GMM leverages geolocation data from users' devices to calculate proximity to declared venues, prioritizing matches within a predefined radius. This ensures that users are only matched with others who are both contextually relevant and geographically feasible for immediate interaction.

The system also incorporates a Venue-Specific Prioritization Algorithm (VSPA) (FIG. 7), which ranks potential matches based on shared venue plans, mutual interests, and historical interaction patterns within the application.

### Operational Controls and Automation

To ensure relevance and maintain system integrity, the bar toggle is governed by a Toggle Deactivation Protocol (FIG. 8). This protocol automatically deactivates the toggle after a user-defined expiration time or upon reaching midnight, whichever occurs first. Users may also manually deactivate the toggle, providing them with complete control over their visibility.

The system includes a Real-Time Synchronization Engine (RTSE) (FIG. 9), which ensures that profile visibility, venue data, and matchmaking parameters are updated instantaneously across all active user sessions. This synchronization mechanism eliminates latency and enhances the fluidity of user interactions.

### Enhanced Graphical User Interface (GUI)

The GUI is a pivotal component of the system, designed to provide an intuitive, visually engaging user experience. Key features include:
A toggle activation button with animated feedback to indicate the feature's status (FIG. 10).
A venue input field with autocomplete functionality to streamline the process of entering bar or venue names (FIG. 11).
A Real-Time Match Display Panel (RTMDP) (FIG. 12) showcasing profiles of users who match the toggle criteria.

The GUI dynamically adjusts to reflect the user's toggle status and declared venue, ensuring a seamless and cohesive interaction flow and turns off after a given amount of time synced to the database.

### Error Handling and Robustness

The system incorporates advanced error-handling protocols to mitigate potential issues, such as incomplete venue data or failed toggle activations. The Error Detection and Recovery Module (EDRM) (FIG. 13) monitors system performance and implements corrective actions in real time, ensuring uninterrupted operation.

1. A computer-implemented system for execution-layer modification of candidate generation within a network-based social discovery platform, comprising:
one or more server systems comprising at least one processor and memory;
a persistent profile data repository stored in the memory and configured to maintain baseline visibility attributes for a plurality of user profiles;
an availability-state data structure stored in the memory in association with each user profile, the availability-state data structure comprising:
an availability flag; and
an expiration timestamp;
a matchmaking engine executed by the at least one processor and configured to generate candidate result sets through execution of structured queries against the persistent profile data repository;
wherein receipt of an activation signal from a user-accessible availability interface causes the at least one processor to:
(i) set the availability flag to an active state;
(ii) include the associated user profile identifier within an availability-restricted candidate index stored in the memory; and
(iii) modify execution of candidate selection queries such that candidate generation is constrained, at query execution time, to user profile identifiers concurrently associated with an active availability flag;
and wherein expiration of the expiration timestamp causes the at least one processor to:
(iv) automatically reset the availability flag to an inactive state; and
(v) restore execution of baseline candidate selection queries independent of the availability-restricted candidate index.

2. The system of claim 1, wherein the matchmaking engine further incorporates device-derived coordinate data as an execution-time ranking variable within the candidate selection queries, the coordinate data being processed by the at least one processor as a dynamic scoring input independent of venue membership state and without requiring association with a predefined venue object.

3. The system of claim 1, wherein the expiration timestamp is evaluated by the at least one processor during execution of candidate selection queries and, upon determining that the expiration timestamp has elapsed, automatically mutates the availability-state data structure and removes the associated user profile identifier from the availability-restricted candidate index without requiring client-side interaction.

4. The system of claim 1, further comprising a synchronization component executed by the at least one processor and configured to detect mutations of the availability-state data structure and propagate corresponding modifications of the availability-restricted candidate index to active client sessions via network transmission, thereby maintaining consistency between server-side execution state and client-visible candidate result sets.

5-10. (canceled)
